(19) United States
(12) Patent Application Publication
(10) Pub. No.: US 2016/0031736 A1
(43) Pub. Date: Feb. 4, 2016

(54) SHAPED GLASS OR GLASS CERAMIC ARTICLE, METHODS FOR PRODUCING THE SAME, AND USE THEREOF

(71) Applicant: SCHOTT AG, Mainz (DE)

(72) Inventors: Oliver Muehlke, Geisenheim (DE); Martin Spier, Mainz (DE)

(21) Appl. No.: 14/814,809

(22) Filed: Jul. 31, 2015

(30) Foreign Application Priority Data
Jul. 31, 2014 (DE) 102014110923.6

(51) Int. Cl. C03B 23/00; C03C 17/28; C03C 17/22

(52) U.S. Cl. CPC C03B 23/0013; C03C 17/22; C03C 17/28; C03C 2218/119

(57) ABSTRACT

The invention provides a method for producing, without using a mold, a shaped green glass or glass ceramic article having a predefined geometry, which method permits to produce fine local textures of high surface quality and with homogeneous properties, in particular with respect to homogeneous nucleation or crystallization.

### CROSS-REFERENCE TO RELATED APPLICATION

The present application claims priority to German Patent Application No. 10 2014 110 923.6, filed on Jul. 31, 2014, which is herein incorporated by reference in its entirety.

### BACKGROUND OF THE DISCLOSURE

1. Field of the Disclosure

The invention relates to a method for producing a shaped green glass or glass ceramic article having a predefined geometry without using a mold, and further relates to the use of the green glass or glass ceramic article produced according to such method, and to the shaped green glass or glass ceramic article.

2. Description of the Related Art

The deformation of glass ceramics or patterning of the surface of a green glass or a glass ceramic has long been state of the art. For example, it has long been known to provide dimples on the lower surface of the glass ceramic or the corresponding green glass directly during the shaping in the molten state by using textured rollers. However, such glass ceramic sheets provided with dimples on one side thereof, which are widely used as a cooktop, only allow a limited view to electro-optical display elements possibly located below the cooktop. Continuous stripes or grooves as well as the formation of trays have been known from prior art and can be produced by rolling processes. However, a drawback therein is that for each different geometry another shaping roller is required, so that a low-cost low-volume production is excluded at the most expensive unit, the trough. Continuous grooves or stripes are very simple to produce by rolling, since these geometries can be easily provided in the roller in radial direction. However, there exist limitations with regard to thickness variations. For example, thickness variations of more than 30% along the roller strip are problematic and lead to undesired deformations. Interrupted geometries such as closed trays (sunken region) are more difficult to produce by rolling and often lead to undesired side effects/deformations in front of and behind the thickness variation.

Besides the hot molding processes described above there are methods in which an already shaped glass or green glass sheet is reshaped in a further step. For example, DE 2503 467 C2 describes a method for bending a glass sheet to a sharp angle. Conductive paste is applied to the intended bending line, and this region is locally heated and deformed through electrical conduction and the resulting heating. However, due to the locally high temperatures a disturbing discoloration occurs in the region of the edge, that has to be concealed by further measures such as by subsequent pigmentation. Moreover, the employed glass is not a green glass.

Unites States Patent Application Publication No. 2010/0000259 A1 substantially describes the bending of glasses preferably by using medium-wave IR radiation which is absorbed particularly well by the glass. Here, again, deformation of a green glass, i.e. a glass ceramic blank, is not described.

German Patent Application No. DE 10 2010 020 439 A1 describes several methods for shaping individual glass articles, inter alia by using a mold and by choosing different temperatures at different points of the glass molding.

Unites States Patent Application Publication No. 2012/0114901 A1 describes a method for producing cover glasses, in which individual sheets are bent by appropriately choosing temperature distribution and appropriately choosing the radii of the mold. The shaping process is terminated as soon as the product contacts the mold over its entire surface.

International Patent Publication No. WO 2011/000012 A1 describes laser-heated bending pressing of materials.

German Patent Application No. DE 10 2011 050628 A1 discloses a bending method without using a mold, in which, however, the radiation sources are configured as radiant burners that have to be re-positioned mechanically depending on the desired bending geometry.

German Patent Application No. DE 101 02576 A1 describes a method for deforming a green glass sheet in which the shaping is achieved by gravity alone during treatment in a furnace, for example during ceramization of the green glass.

German Patent Application No. DE 100 47576 A1 describes the reshaping of a green glass before or during ceramicization of the glass ceramic, in which again the deformation itself is caused by the action of gravity on the glass which is deformable during ceramization, and with IR-burner that are used for promoting the heating process. Optional promoting or reinforcing measures for shaping include vacuum deep drawing, press die, and compressed air.

Another variant of reshaping is described in German Patent Application No. DE 10 2007 012146 B4. Here, a combination of laser beam and scanning mirror is used to locally raise the temperature in the glass sheet to be shaped and to deform it through the action of gravity. However, in this case an accurate temperature measurement is additionally necessary, since the temperature directly controls the viscosity and therefore also the deformation. Although this is a method without mold, a green glass is not used herein either.

All these methods have in common that they either require molds of excellent surface quality which are very complicated and expensive to manufacture, or require reworking by grinding and polishing, or require time-consuming adjustments of the shaping system. This results in high complexity and high costs.

In addition, all of the aforementioned reshaping methods have in common that the deformations obtained thereby are subject to major limitations. For example, the above-mentioned methods only permit to realize deformations with large radii; fine local textures cannot be achieved. This is in particular due to the fact that for fine local textures the force of gravity alone does not suffice for a sufficient deformation since surface tension keeps the glass in shape. In order to achieve fine textures, external forces F have to be applied, for example by using a mold. In this case, the following relationship applies for the depth of deformation or depending on the embodiment also the height of deformation, T:

T=(AdρBg+F)/(γI),

with
A=lowered area of the starting glass, in m²,
ρ=glass density, in kg/m³,
g=9.81 m/s²,
γ=surface tension of the starting glass in the molten state, in N/m,
d=thickness of the starting glass, in m,
B=width of the deformation, in m,
I=circumference of the deformation, in m,
F=sum of external forces, in N.

However, if molds are used for forming the glass, such as for example in German Patent Application No. DE 10 2010 020 439 A1, surface defects are often caused, which are known as pits.

Another difficulty in reshaping green glass or glass ceramic articles is in particular that during heating first the range of nucleation is traversed. In order to achieve homogeneous ceramization and thus ultimately homogeneous properties of the resulting glass ceramic sheet, it is very important to rapidly pass through the critical temperature range of nucleation. This range is characterized by a formation of numerous crystallization nuclei in the green glass which is provided as a starting glass and is, for example, in a range from 700 to 850° C. for common LAS glass ceramics.

### SUMMARY OF THE DISCLOSURE

Therefore, an object of the invention is to find a method for producing a shaped green glass or glass ceramic article having a predefined geometry without using a mold, which method overcomes the described drawbacks of the prior art, and which permits to produce, in a green glass or a glass ceramic, fine local textures with high surface quality and homogeneous properties, in particular in terms of homogeneous nucleation and crystallization. A further object of the invention is to provide for easy and cost-efficient manufacturing of shaped green glass or glass ceramic articles that exhibit high surface quality in the shaped region and in particular to avoid post-processing steps and complex temperature measurements.

Surprisingly, it has been found that the object can be achieved very easily according to claim 9 by a method for producing, without a mold, a shaped green glass or glass ceramic article having a predefined geometry, the method comprising at least the steps of:
providing a sheet-like starting glass having a composition of a green glass;
supporting the starting glass;
heating a portion of the starting glass so as to obtain in this portion a viscosity of the starting glass from 10⁹ to 10⁴ dPa·s, in particular from 10⁸ to 10⁴ dPa·s, and so that at the points where the starting glass is supported a viscosity of the starting glass does not fall below 10¹² dPa·s, preferably not below 10¹³ dPa·s, wherein the heating is accomplished along a closed line using at least one laser beam and in such a way that the temperature range from 700 to 850° C. which is relevant for nucleation in the green glass and which is distinguished by strong a formation of crystallization nuclei, is crossed in a few seconds, preferably in not more than 50 seconds; and
deforming the heated starting glass by action of an external force until the predefined geometry of the glass article is obtained; and optionally
converting the green glass into a glass ceramic by subsequent ceramization.

The object is furthermore achieved by a shaped green glass or glass ceramic article obtained from a starting glass, which comprises at least one deformation of a deformation depth T (or, depending on the embodiment, a deformation height), with:

T>(AdρBg)/(γI),

wherein
A=lowered or elevated area of the starting glass, in m²,
ρ=glass density, in kg/m³,
g=9.81 m/s²,
γ=surface tension of the starting glass in the molten state, in N/m,
d=thickness of the starting glass, in m,
B=width of the deformation, in m,
I=circumference of the deformation, in m;
wherein after having been deformed, the surface of the shaped green glass or glass ceramic article has no defects greater than 1 μm, in particular not greater than 0.1 μm.

A, d, ρ, B, γ, and I can be measured on the shaped green glass or glass ceramic article, and, if applicable, the length values obtained on the glass ceramic article can be corrected by a conversion factor taking into account the shrinkage occurring during ceramization.

Defects substantially refer to surface defects that may be caused by contacting a mold.

The term “without using a mold” in the sense of the invention means that the heated portion does not come into contact with a mold.

The starting glass employed is a glass having a composition of a green glass, and in the context of the present invention a green glass refers to a glass which can be converted into a glass ceramic by a specific heat treatment or ceramization.

The starting glass preferably used is a lithium aluminum silicate glass.

Preferably, the lithium aluminum silicate glass has the following composition:

60-73.0 wt % SiO₂
15-25.0 wt % Al₂O₃
2.2-5.0 wt % Li₂O
0-5.0 wt % CaO + SrO + BaO
0-5.0 wt % TiO₂
0-5.0 wt % ZrO₂
0-4.0 wt % ZnO
0-3.0 wt % Sb₂O₃
0-3.0 wt % MgO
0-3.0 wt % SnO₂
0-9.0 wt % P₂O₅
0-1.5 wt % As₂O₃
0-1.2 wt % Na₂O + K₂O, with respective proportions within the ranges of
0-1.0 wt % Na₂O,
0-0.5 wt % K₂O, and
0-1.0 wt % of coloring oxides.

According to a preferred embodiment of the invention, the green glass article is relaxed after shaping in order to relieve stresses caused in the glass during the shaping. The relaxation of the glass is preferably accomplished at a temperature just above T_{G}. T_{G} denotes the glass transition temperature or transformation point of the glass and is usually distinguished by a viscosity from 10¹² to 10¹³ dPa·s.

According to a further embodiment of the method, the starting glass is preheated. This is preferably accomplished in a separate furnace. Here, the preheating temperature T_{V} is preferably a temperature not more than 150 K below the lower temperature limit T_{U} of the temperature range in which formation of crystallization nuclei starts. In the context of the present application, T_{U} is referred to as lower nucleation temperature.

In a preferred embodiment the starting glass is preheated to a temperature of at least 300° C., preferably to a temperature of up to 450° C., depending on the deformation geometry even to slightly above T_{G}. This preheating is favorable in order to rapidly reach the desired temperature for producing the sunken area. In particular when reshaping a glass element, a resulting advantage is that the temperature range of nucleation is rapidly traversed, so that premature ceramization is suppressed. Moreover, mechanical stresses resulting after cooling are minimized in this way, since the temperature increase required for reshaping is reduced.

According to one embodiment of the method, the reshaped green glass article is converted into a glass ceramic in a subsequent step, by ceramization.

Preferably, the heating parameters, in particular the viscosity to be achieved in the portion of the starting glass to be deformed, and the deformation parameters, in particular deformation time and deformation force, are chosen so that the deformation ceases when the desired geometry of the starting glass is obtained.

According to another embodiment of the method, the heating of the portion is promoted using at least one burner, or by IR radiation.

According to another embodiment, the heating of the portion may be accomplished using a laser beam, wherein in one embodiment the portion is scanned at a frequency of the laser beam of at least 2 Hz or is continuously irradiated using a fixed optical system.

Lasers having a wavelength between about 1 μm and about 5 μm are preferably used, e.g. a diode laser having a wavelength of about 1 μm. In this way it is possible to heat the starting glass, e.g. green glass, in a locally sharply defined manner and with a large temperature gradient. Favorably, a laser wavelength is used at which the starting glass to be reshaped exhibits an absorptivity between 10 and 90%. For forming a sunken area, a laser wavelength with a low absorptivity between 10 and 50% is preferably used, since in this manner the energy input will be quite constant throughout the thickness of the starting glass.

The entire portion can be heated at the same time or consecutively over time.

Heating is preferably effected along a closed line.

Heating may be effected in such a manner that a predefined temperature gradient is adjusted between the portion to be deformed and the remaining regions of the starting glass.

This temperature gradient is preferably measured using suitable measuring methods, in particular a thermal imaging sensor. Additionally or alternatively the deformation may be measured by suitable measuring methods, in particular by means of optical and/or acoustic sensors.

The external force F applied for deformation purposes may in particular be exerted on the heated starting glass by vacuum deep drawing or pressure blowing.

The external force applied for deformation purposes may be exerted by a pressure difference across the starting glass.

The external force applied for deformation purposes may likewise be transmitted via a mechanical punch or a vacuum mold having a milled recess, in which case the punch or the mold preferably only contact points of the glass sheet that have a high viscosity, i.e. a temperature less than or equal to T_{G}, or a viscosity not below 10¹² dPa·s, preferably not below 10¹³ dPa·s.

The obtained green glass or glass ceramic article preferably has no defects (pits) of a size greater than 1 μm, in particular not greater than 0.1 μm on the surface of the reshaped portion. Reshaped portion herein refers to that portion which had a viscosity from 10⁹ to 10⁴ dPa·s during reshaping.

The reshaping of the sheet-like starting glass is performed so that in the reshaped portion which is distinguished by a viscosity from 10⁹ to 10⁴ dPa·s, preferably from 10⁸ to 10⁴ dPa·s during reshaping, the obtained deformation is formed so that the surface profile of the green glass or glass ceramic article obtained according to the present invention has rounded deformation edges in the deformed portion which can be described by curvature radii or deformation radii. The green glass or glass ceramic article obtained has deformation radii ranging from 0.4 to 15 mm.

According to the invention, the green glass or glass ceramic article produced according to the methods of the invention can be used as a glass ceramic cooktop.

The resulting deformation in the surface of the green glass or glass ceramic in the reshaped portions may be formed as a depression or as an elevation.

Preferably, this deformation of the green glass or of the glass ceramic is accomplished along a line.

The obtained deformation of the green glass or glass ceramic preferably has a depth from 0.1 to 2.5 mm or, depending on the embodiment, a height from 0.1 to 2.5 mm.

According to another preferred embodiment of the invention, a shaped green glass or glass ceramic article of predefined geometry is obtained by the method for producing, without a mold, a shaped green glass or glass ceramic article, which comprises at least one decoration made from a printing ink. For this purpose, the method comprises the steps of:
providing a sheet-like starting glass;
supporting the starting glass;
heating a portion of the starting glass so that a viscosity of the starting glass, in this portion, is obtained from 10⁹ to 10⁴ dPa·s, in particular from 10⁸ to 10⁴ dPa·s, and so that at the points where the starting glass is supported a viscosity of the starting glass does not fall below 10¹² dPa·s, preferably not below 10¹³ dPa·s, wherein the heating is accomplished using at least one laser beam along a closed line and in such a way that the temperature range relevant for nucleation and characterized by a strong formation of crystallization nuclei is crossed in not more than 50 seconds;
deforming the heated starting glass by action of an external force until the predefined geometry of the glass article is obtained;
applying at least one printing ink to a predetermined region of the starting glass; and
optionally converting the green glass into a glass ceramic by subsequent ceramization.

Here, a ceramic ink is an ink which is made of a glass flux and coloring components. Such ceramic inks are described in DE 198 34 801 A1, for example. Furthermore, other printing inks may be used, for example commercially available organic inks, or semi-organic inks such as sol-gel inks.

According to yet another preferred embodiment of the invention the applying of the at least one printing ink is accomplished by a printing process, preferably by screen printing, pad printing, and/or jet printing such as inkjet printing.

According to a further embodiment of the invention the at least one printing ink is applied in the region of the deformation, inter alia, and in this case the deformation is formed as a depression or as an elevation, wherein the elevation has a maximum height of 0.5 mm, and wherein the application of the ink is accomplished by screen printing.

Depending on the specific processing it is possible in this case to apply the printing ink for creating the decoration already before the starting glass is deformed. However, it is also possible to apply the decoration when the deformation has been accomplished.

To prevent overheating of the decoration, the heat affected zone of the green glass or glass ceramic article, that is the area in which the surface temperature of the substrate to be deformed exceeds the maximum allowable temperature of the applied ink, remains free of ink. The maximum allowable temperature is defined as the temperature at which the properties of the ink change irreversibly, for example due to a color change of pigments, decomposition of an organic binder, or the like.

If the obtained reshaped glass ceramic article is employed as a cooktop, electronic elements with control functionality for the cooktop, such as sensors or electro-optical elements with display functionality (displays) are disposed in the deformed region, i.e. the lowered region. Firstly, this has the advantage that the thermal load to which the control elements are exposed during operation of the cooktop and when handling hot cooking equipment is reduced due to the depression and the resulting air gap between the glass ceramic and the pot, which has a thermally insulating effect.

On the other hand it has been found, surprisingly, that the green glass or glass ceramic articles produced according to the invention have a plano-convex surface, depending on a precise process control during deformation. If the control element is an electro-optical display element, the high surface quality of the region deformed according to the invention and its slight piano-convex shape provide for a brilliant view on the display element.

Depending on a precise process control it is likewise possible to produce a deformation having another surface shape. Besides a flat surface it is possible, for example, to obtain deformations that have a peripheral circumferential indentation, or to adjust a concavely curved surface. Combinations of these features are also possible. Such surface textures are particularly relevant for the haptics of the cooktop and thus increase operating convenience thereof.

### BRIEF DESCRIPTION OF THE FIGURES

FIG. 1 shows a flow chart of preferred method steps.

FIG. 2 illustrates the creation of a deformation in a green glass which is supported at its periphery during the deformation process, and a green glass or glass ceramic article of the invention, with a top plan view of the glass article being shown in the upper part, and a cross-sectional view taken along line A-B in the lower part.

FIGS. 3 to 5 schematically illustrate cross-sectional profiles of possible shapes of the bottom of the deformation produced according to the invention.

FIG. 6 shows the transmittance characteristic of a sheet-like starting glass according to the invention having a thickness of about 4 millimeters.

FIG. 7 shows explanations about the measurement method for determining the surface profile of deformations obtained according to the invention.

FIGS. 8 to 15 show resulting contour scans of deformations obtained according to the invention and photographs of selected deformations obtained according to the invention.

FIG. 16 is a schematic cross-sectional view of the deformation produced according to the invention in a green glass or glass ceramic article which additionally has a decoration of a printing ink provided thereon.

### DETAILED DESCRIPTION OF THE DISCLOSURE

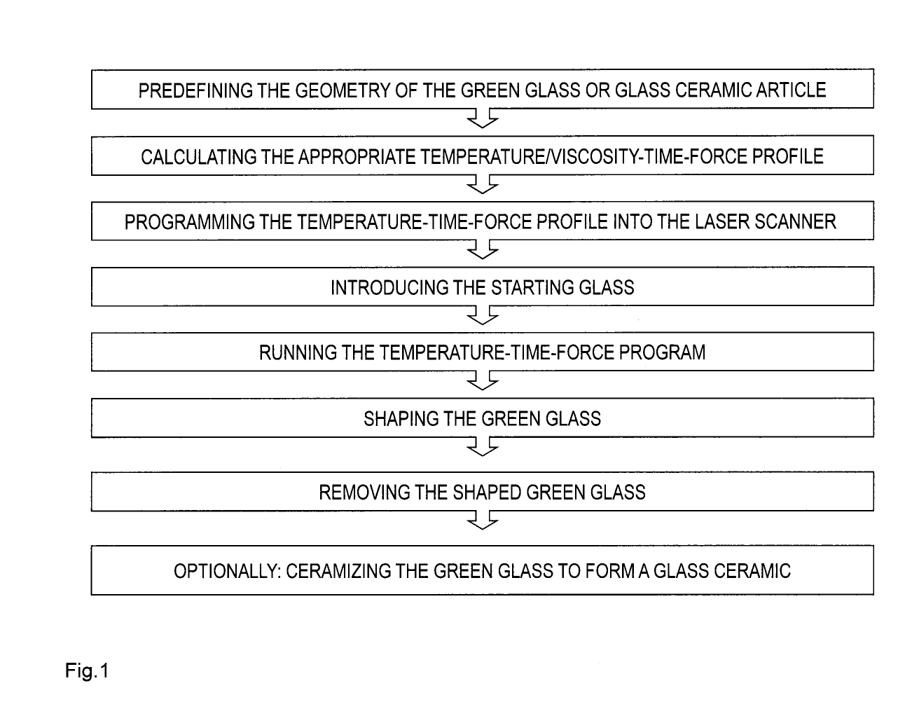

FIG. 1 illustrates, by way of example, a flow chart showing preferred method steps for producing the shaped green glass or glass ceramic article without using a mold. Initially the desired geometry is specified. In the next step it is calculated, what temperature and what force needs to be applied and how long in order to obtain the desired deformation (temperature/viscosity-time-force profile). The heating is to be effected by a laser beam, so in the next step a laser scanner is programmed with the data calculated in step 2. The applied force is set by adjusting a differential pressure across the sheet-like starting glass. In step 4, the starting glass is provided and supported, in order to finally run the respective shaping program in the next step, during which the temperature range of nucleation which is distinguished by a formation of numerous crystallization nuclei, is traversed within a few seconds, preferably within not more than 50 seconds. In this way the green glass is shaped in step 6. In step 7, the shaped green glass is removed. Optionally, in a subsequent step, ceramization of the green glass is effected to form a glass ceramic.

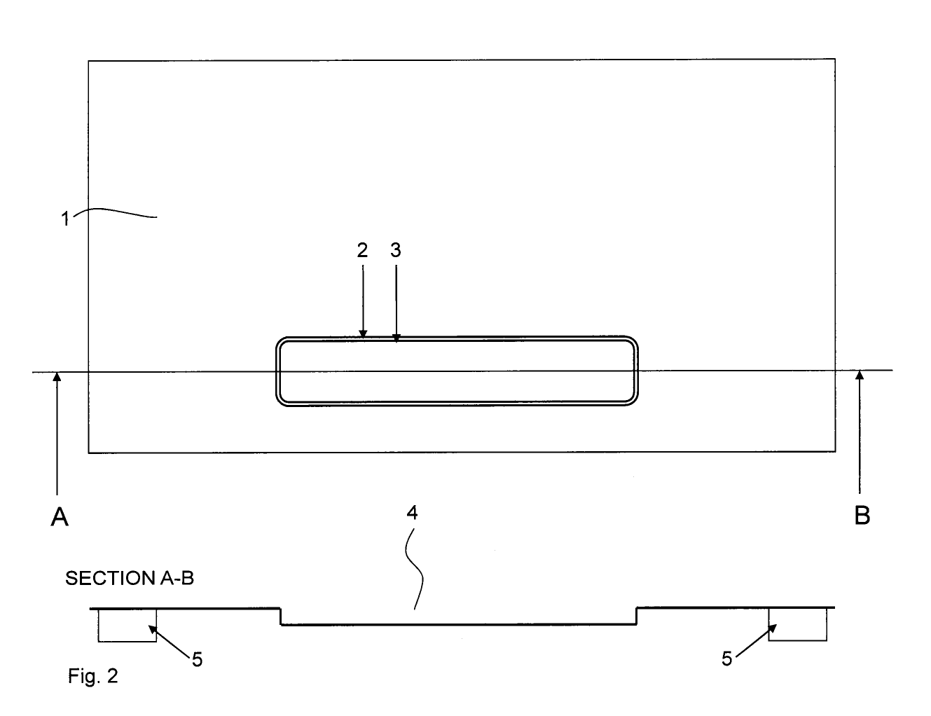

FIG. 2 schematically shows a deformation 4 in a green glass (deformed green glass 1) which is supported at its periphery by means of supports 5 during the deformation process. In portion 2 the starting glass is heated to such a temperature that a viscosity from 10¹³ to 10⁷ dPa·s is obtained in this portion, while in portion 3 the viscosity is adjusted in a range from 10⁹ to 10⁴ dPa·s, preferably from 10⁸ to 10⁴ dPa·s. In the region of supports 5, the viscosity of the starting glass does not fall below 10¹² dPa·s, preferably not below 10¹³ dPa·s. The starting glass heated in this manner deforms under the action of its own weight in combination with an external force until the predefined geometry of the green glass is obtained.

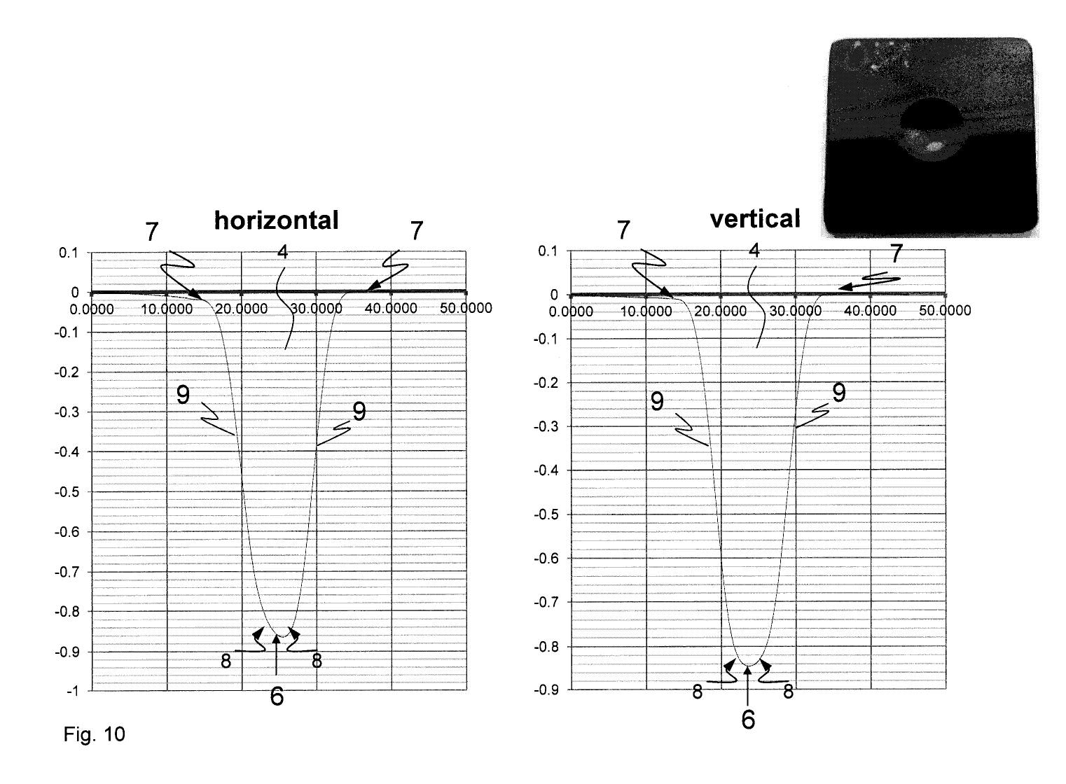

If the heating is accomplished so that a deformation 4 is produced which has a bottom 6 that is merely shifted relative to the original surface of the starting glass, this bottom 6 will also have a viscosity from 10¹³ to 10⁷ dPa·s during the deformation process, that means a viscosity corresponding to that of portion 2. However, if during the deformation process the bottom 6 itself is also deformed, it will have a viscosity from 10⁹ to 10⁴ dPa·s during deformation, preferably from 10⁸ to 10⁴ dPa·s, that means a viscosity corresponding to that of portion 3 (see FIG. 10).

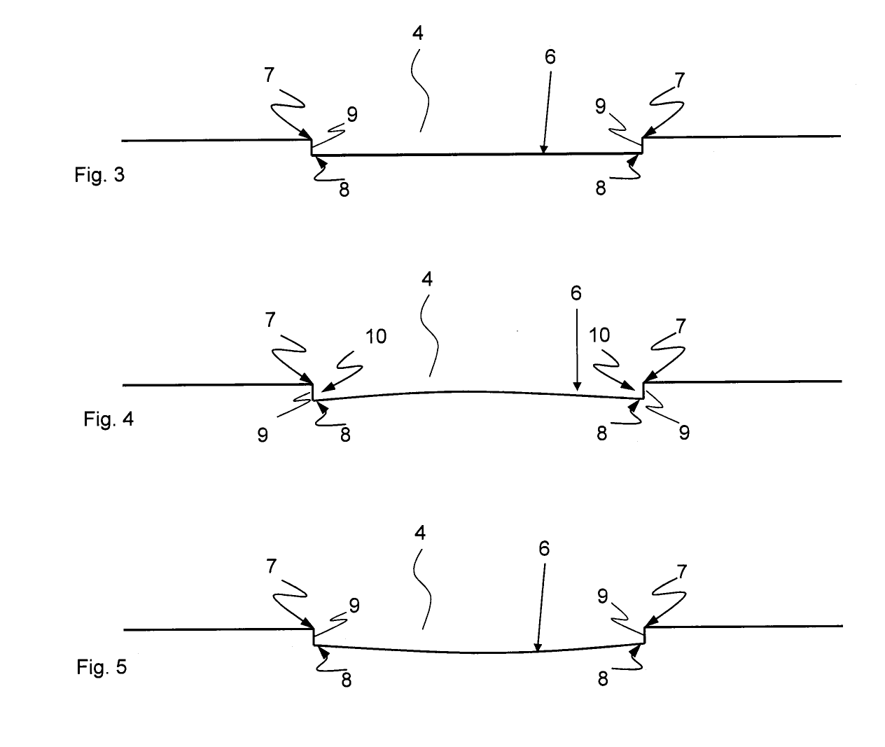

FIGS. 3 to 5 schematically show cross-sectional views of possible shapes of the surface profile in deformation 4 which is formed as a depression, by way of example:

FIG. 3 schematically shows the surface profile of the shaped green glass in form of a cross-sectional profile. Bottom 6 has a flat surface, i.e. it is not curved. Furthermore shown are the shoulders 7 and the edges 8 of the cross-sectional profile of the deformation. In the context of the present application, shoulder 7 refers to that region of the shaped green glass or glass ceramic article 1 where in the cross-sectional profile a higher region transitions into the wall 9 of the deformation 4 of the shaped green glass or glass ceramic article 1, and edge 8 refers to that region of the shaped green glass or glass ceramic article 1 in which the wall 9 of deformation 4 transitions into the lower region. The region of the shaped green glass or glass ceramic article 1 which is located between and limited by the walls 9 of the deformation 4 is referred to as bottom 6.

FIG. 4 schematically illustrates the surface profile of a deformation 4 in which the bottom 6 has an upwardly curved convex shape. Shown are shoulders 7, edges 8, and walls 9, as well as a circumferential indentation 10 within deformation 4, which extends around bottom 6. Such an indentation will exist in particular in case of an upwardly curved convex shape of the surface within deformation 4 and will be explained in more detail with reference to further exemplary embodiments based on contour scans of samples produced according to the invention.

In FIG. 5 bottom 6 has a downwardly curved concave shape. Also shown are the shoulders 7, edges 8, and walls 9 of the deformation 4.

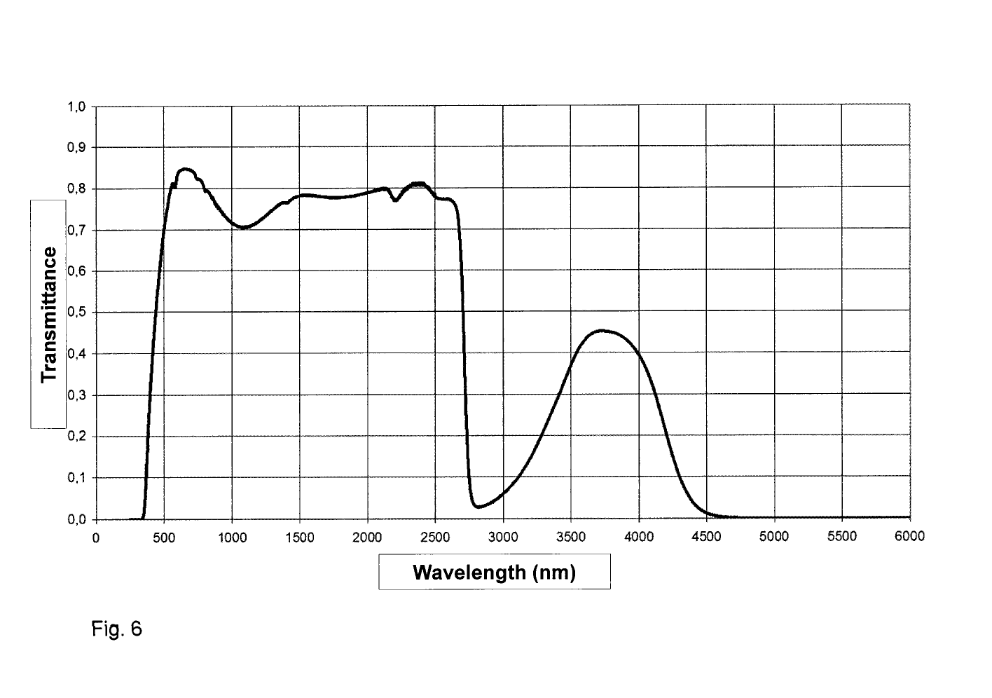

FIG. 6 illustrates data of optical transmittance for a sheet-like glass having a thickness of about 4 mm, which can be used as the starting glass according to the invention. The data were acquired for a glass having flat surfaces on both sides.

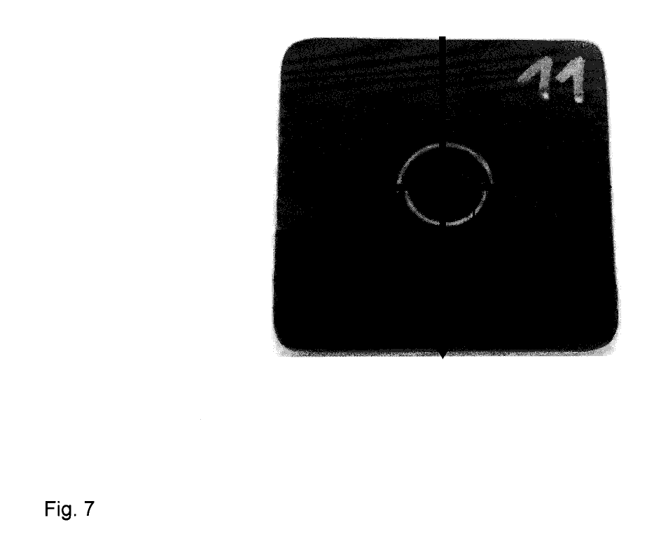

FIG. 7 shows a photograph of an exemplary sample having a size of approximately 50 mm*50 mm. The contour scan measurement of a deformation obtained according to the invention is performed in the directions as indicated by the arrows, i.e. from right to left in the horizontal direction, and from top to bottom in the vertical direction and so that the reshaped contour is traversed centrally. The measuring range covers approximately 45 mm, with a resolution of 5 μm. The number of resulting measuring points is 9039.

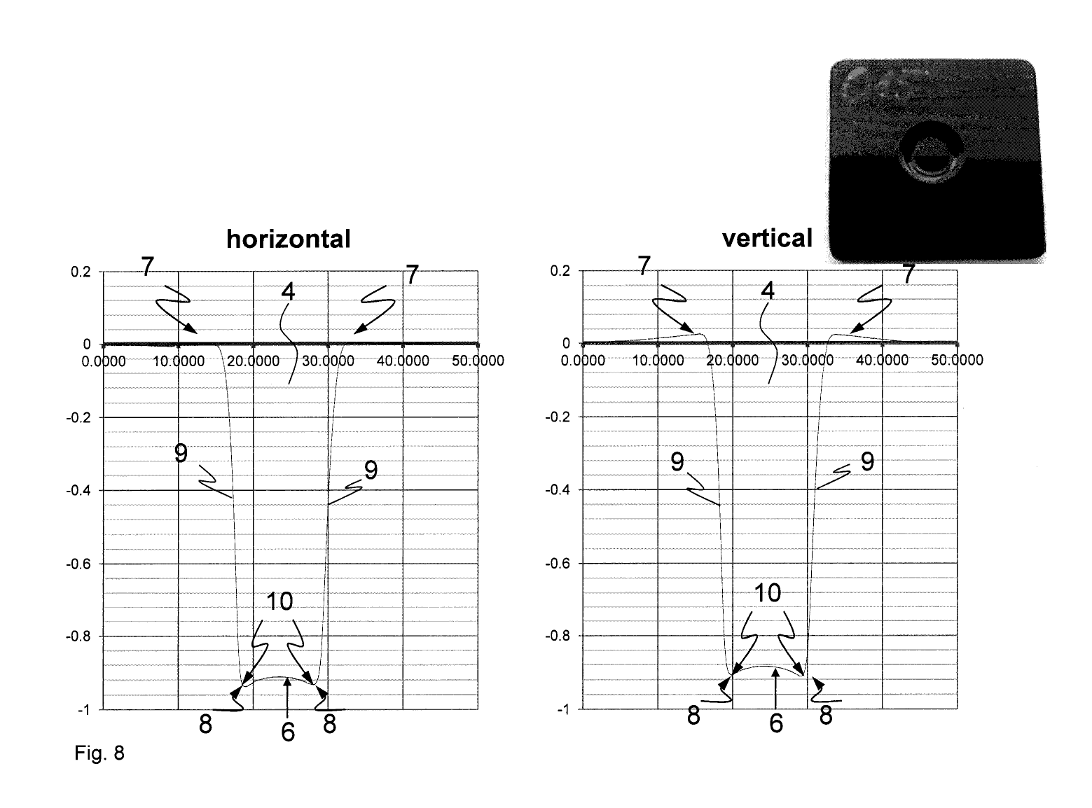

FIG. 8 shows, on top, a photograph of a sample having dimensions of approximately 50 mm*50 mm, with a circular deformation 4 in form of a depression in the center, which was obtained by the method according to the invention. The axes of the graphs represent mm in each case. Following the reshaping process the sample was ceramized. Also shown are two contour scans of the resulting deformation 4, which were measured on the surface of the glass ceramic along two perpendicular lines. The left scan shows the surface shape profile in the horizontal direction, the right scan in the vertical direction. Clearly visible is the convex shape of the surface profile within deformation 4, with an indentation 10 around the bottom 6 within the deformation 4. Also, the approximate positions of shoulders 7, edges 8, and walls 9 are shown. Furthermore noticeable is a slight bulging of the surface in the region of shoulders 7 in the vertical measurement profile before the surface lowers. The circumferential indentation 10 in the edge region is clearly visible.

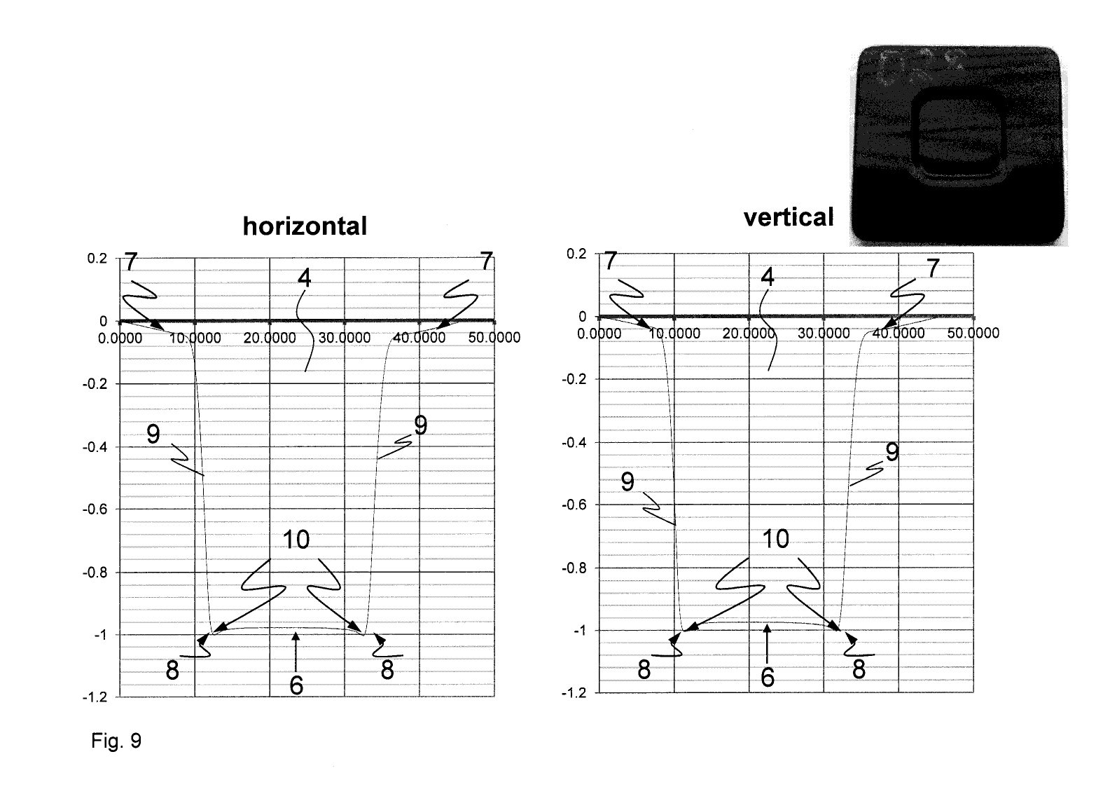

FIG. 9 shows, on top, a photograph of another glass ceramic sample having dimensions of approximately 50 mm*50 mm, in which a rectangular deformation 4 with rounded corners in form of a depression was obtained by the method according to the invention. The axes of the graphs represent mm in each case. Here, again, ceramization was performed following the reshaping process. In the contours scans which are again shown below, one in horizontal direction and one in vertical direction, the convex surface profile within deformation 4 and the indentation 10 extending around bottom 6 within the deformation 4 are again clearly visible. Furthermore, the positions of shoulders 7, edges 8, and walls 9 are shown.

FIG. 10 shows a further deformation 4 of yet another sample obtained according to the invention. The axes of the graphs represent mm in each case. Here, a circular depression was obtained with the method according to the invention, with the bottom 6 concavely curved downwards. Shoulders 7 of the deformation 4 are also shown. Due to the concave shape of the bottom, the region of the left edge 8 smoothly transitions into the region of the right edge 8, so that the radius obtained in bottom 6 is considered as the edge radius. Furthermore, walls 9 of deformation 4 are indicated.

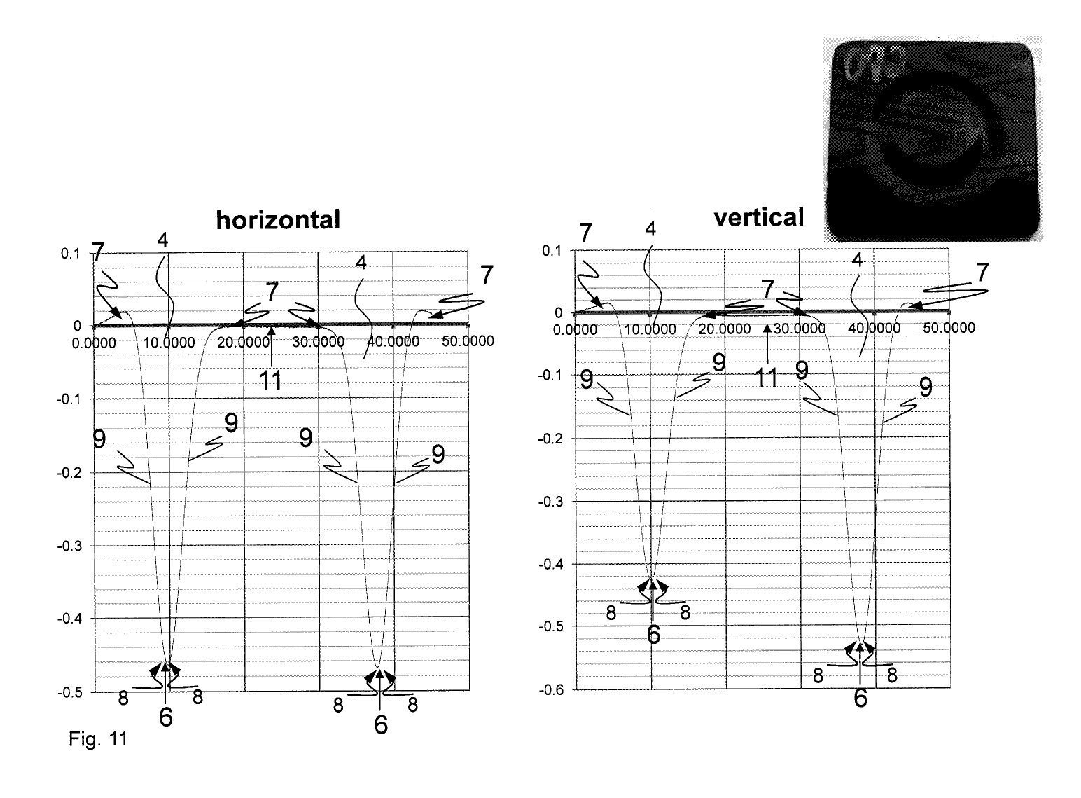

FIG. 11 shows a further embodiment of the invention on a glass ceramic sample. The axes of the graphs represent mm in each case. In this case, reshaping was effected along a line such that the deformation 4 obtained is in form of a sunken ring around a non-sunken area 11 when compared to the surface profile prior to the deformation process. In the region of shoulders 7 a slight bulging of the surface is discernable in front of the deformation 4. The bottom 6 of deformation 4 is concavely curved downwards. Again, due to the concave shape of bottom 6 the left edge 8 smoothly transitions into the right edge 8, so that the radius obtained in bottom 6 is considered as the edge radius. Furthermore, walls 9 of deformation 4 are indicated.

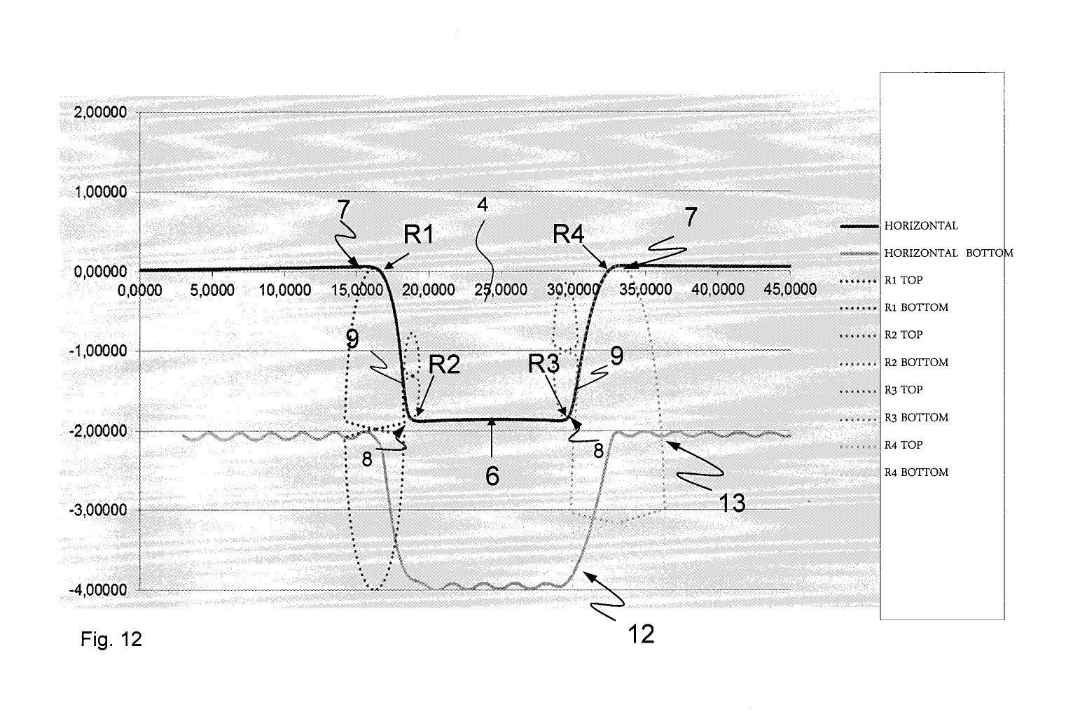

FIG. 12 shows a contour scan of a deformation 4 in form of a depression obtained according to the invention, in the horizontal measuring direction, with radii measured on a sample in the non-ceramized (i.e. “green”) state. The axes of the graph represent mm in each case. In addition to the contour profile of the upper surface of the shaped sheet-like glass 1, the surface profile of the lower surface 12 is shown. Clearly visible herein is the dimpled texture 13 of the lower surface 12 of the reshaped sheet-like green glass. Furthermore, shoulders 7, edges 8, and walls 9 of the deformation 4 are indicated. On the basis of this contour scan, the deformation radii of shoulders 7 and edges 8, denoted by R1 through R4, were determined. The following values were obtained, rounded to the second decimal place:

R1: 2.02 mm

R2: 0.54 mm

R3: 0.85 mm

R4: 3.23 mm.

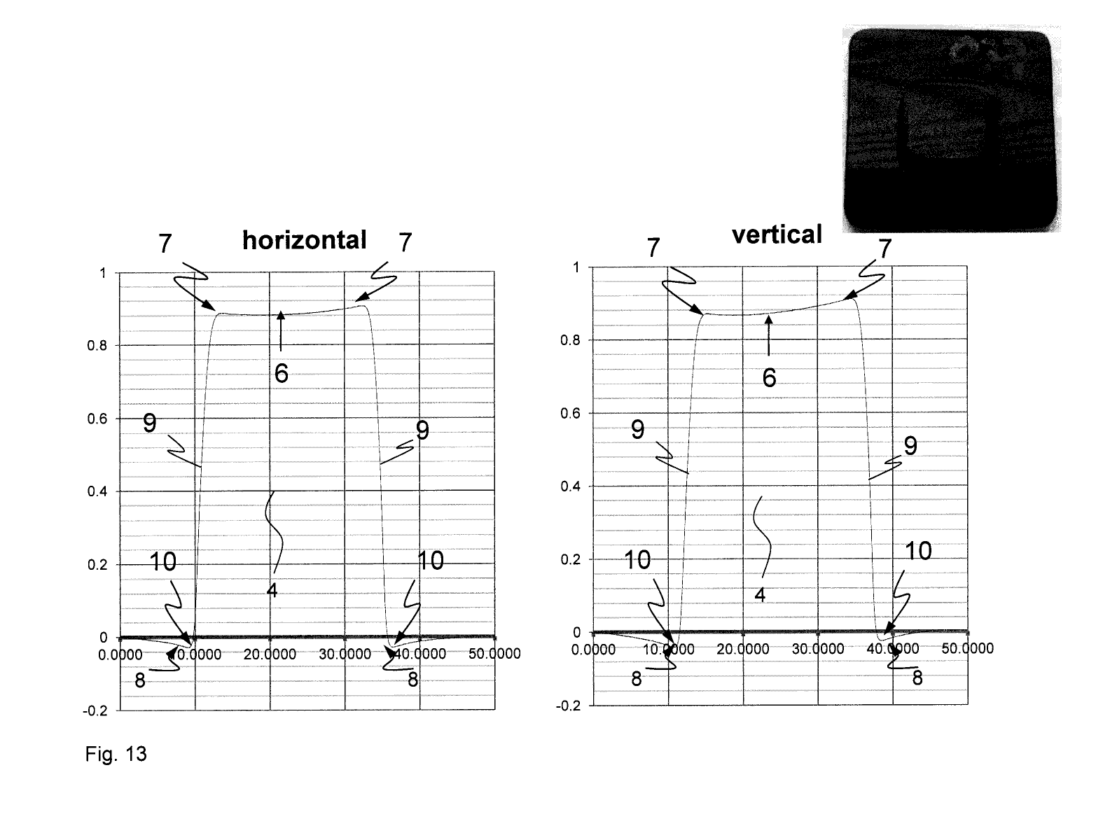

FIG. 13 shows a further embodiment of the invention on a glass ceramic sample. The axes of the graphs represent mm in each case. In this case, deformation 4 is provided in form of an elevation. Here, again, a circumferential indentation 10 is formed around bottom 6 of deformation 4. Furthermore, shoulders 7, edges 8, and walls 9 of deformation 4 are indicated.

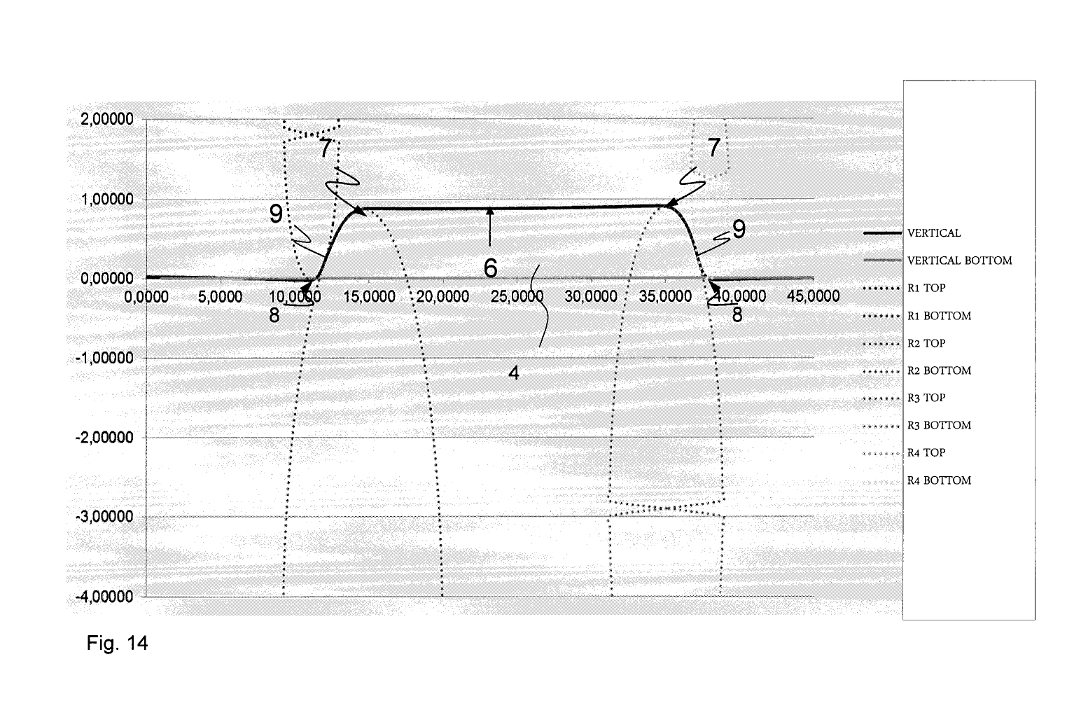

FIG. 14 shows a contour scan of a deformation 4 in form of an elevation obtained according to the invention. The axes of the graph represent mm in each case. Furthermore, shoulders 7, bottom 6, edges 8, and walls 9 of the obtained deformation 4 are indicated.

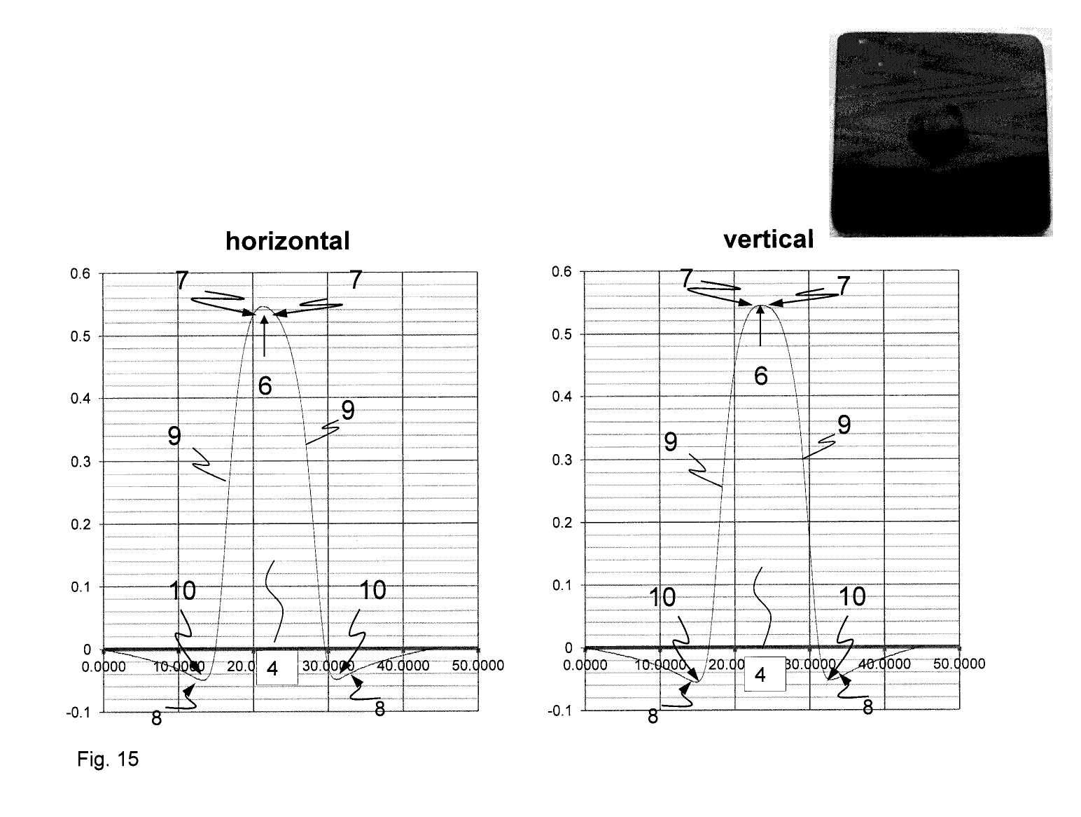

FIG. 15 shows a further embodiment of the invention on a glass ceramic sample. The axes of the graphs represent mm in each case. In this case, deformation 4 is provided in form of an elevation, with a bottom 6 having a convexly upwardly curved shape and formed so that due to the convex shape of the bottom 6 the left shoulder 7 of the deformation smoothly transitions into the right shoulder 7 of the deformation 4, so that the radius obtained in bottom 6 is considered as the shoulder radius. Furthermore, edges 8, and walls 9 of deformation 4 are indicated, as well as the circumferential indentation 10 extending around bottom 6 of deformation 4.

A detailed examination of the contour scans of the deformations 4 according to the invention as illustrated in FIGS. 8 to 15 shows that the deformation radii in the region of shoulders 7 are always greater than the deformation radii obtained for the region of edges 8.

Table 1 below lists the radii of the shoulder and edge regions, in each case determined in the horizontal and vertical contour scans. The respective direction of measurement is specified by an h (for horizontal) or by a v (for vertical) following the sample number. All radii are given in mm and were rounded to the second decimal place.

TABLE 1

| | Radius left | Radius left | Radius right | Radius right |
|---|---|---|---|---|
| Sample No. | shoulder R_{S, l} | edge R_{R, l} | edge R_{R, r} | shoulder R_{S, r} |
| 028 h | 4.53 | 1.76 | 2.21 | 5.98 |
| 028 v | 4.30 | 1.59 | 2.48 | 5.90 |
| 051 h | 4.53 | 1.76 | 2.21 | 5.98 |
| 051 v | 4.27 | 1.59 | 2.48 | 5.90 |
| 072 h | 4.53 | 1,76 | 2.21 | 5.98 |
| 072 v | 4.27 | 1.59 | 2.48 | 5.90 |
| 188 h | 4.72 | 2.11 | 2.45 | 6.21 |
| 188 v | 4.75 | 2.08 | 2.42 | 5.86 |
| 194 h | 3.17 | 0.90 | 1.32 | 4.67 |
| 194 v | 3.25 | 0.93 | 1.26 | 4.62 |
| 197 h | 4.72 | 2.11 | 2.45 | 6.11 |
| 197 v | 4.75 | 2.08 | 2.42 | 5.86 |
| 210 h | 2.02 | 0.54 | 0.85 | 3.23 |
| 210 v | 2.01 | 0.51 | 0.86 | 3.16 |
| 217 h | 4.60 | 1.92 | 2.03 | 5.61 |
| 217 v | 4.86 | 1.94 | 2.11 | 5.79 |

A determination of the ratio of shoulder radii to edge radii, V_{S/R}, showed that for a deformation obtained according to the invention this ratio is always in a range from 2 to 4. The ratio of shoulder radii to edge radii, V_{S/R}, suitably results from the following formula:

$${V}_{S / R} = \frac{( {R}_{S , l} + {R}_{S , r} )}{( {R}_{R , l} + {R}_{R , r} )} .$$

Generally, the local curvature radii can be determined from the measured values of a contour scan using a 3-point method. For this purpose, vectors

$${a}^{->} = {BC}^{} = ( \begin{matrix}{C}_{x} - {B}_{x} \\ {C}_{y} - {B}_{y} \\ {C}_{z} - {B}_{z}\end{matrix} ) , \\ {b}^{->} = {CA}^{} = ( \begin{matrix}{A}_{x} - {C}_{x} \\ {A}_{y} - {C}_{y} \\ {A}_{z} - {C}_{z}\end{matrix} ) , \\ {c}^{->} = {AB}^{} = ( \begin{matrix}{B}_{x} - {A}_{x} \\ {B}_{y} - {A}_{y} \\ {B}_{z} - {A}_{z}\end{matrix} )$$

are determined, which represent connecting vectors between three points A, B, C of the contour or surface profile. In the notation illustrated above, contour points A, B, C each have three coordinates. However, the method may as well be applied to a two-dimensional contour scan as shown in FIG. 11 by way of example, for example by setting z-coordinates A₂, B₂, C₂ to zero.

With the vectors according to equations it is then possible to determine quantities

$$s = \frac{1}{2} * ( \vert {a}^{->} \vert + \vert {b}^{->} \vert + \vert {c}^{->} \vert ) and$$

$$A = \sqrt{s * ( s - \vert {a}^{->} \vert ) * ( s - \vert {b}^{->} \vert ) * ( s - \vert {c}^{->} \vert )}$$

from the absolute values of the vectors. The radius of curvature then results as the radius of a circle passing through points A, B, C

$$\begin{matrix}r = \frac{( \vert {a}^{->} \vert * \vert {b}^{->} \vert * \vert {c}^{->} \vert )}{4 A}\end{matrix} .$$

To obtain a more accurate value for the radius of curvature, it is furthermore possible to average the radii of curvature of several triples of different points A, B, C. In this manner, radii between 1 and 8 mm are obtained for the shoulder radii, preferably between 2 and 6.5 mm, and radii between 0.4 and 3 mm, preferably between 0.4 and 2.5 mm are obtained for the edges.

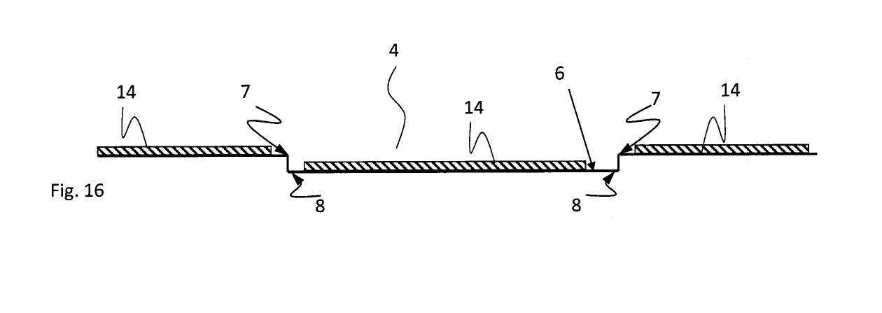

FIG. 16 schematically illustrates yet another embodiment of the invention. Shown is a deformation 4 in a green glass or glass ceramic article obtained according to the invention, which deformation 4 has a bottom 6, and shoulders 7 and edges 8, and walls 9 as well, which however are not denoted here for the sake of clarity. Additionally, the green glass or glass ceramic article obtained from a sheet-like starting glass has at least one decoration 14 on the surface, which at least one decoration comprises a printing ink.

Decoration 14 comprises a printing ink, for example in form of a ceramic ink, an organic ink, or a semi-organic ink, such as a sol-gel ink, or a luster ink, which is for instance used to mark cooking zones or to label other functional areas of a cooktop.

The printing ink is preferably applied by a screen printing process. However, other methods for surface decoration are suitable as well, for example printing processes such as inkjet printing or pad printing.

According to a further embodiment of the invention, the decoration 14 for at least one deformation 4 is applied in the deformed region 4 itself. Furthermore, the green glass or glass ceramic article according to the invention may have further deformations 4 which may also be provided with a decoration 14, but may as well have no decoration 14.

According to yet another embodiment of the invention, the decoration of at least one deformation 4 is applied in the region of the deformation 4, and the deformation is provided in form of a depression or an elevation, wherein the elevation has a maximum height of 0.5 mm, and wherein furthermore the decoration 14 is applied by screen printing.

Moreover, it has been found that the application of the decoration on the green glass or glass ceramic article obtained according to the invention may be accomplished in two ways.

For example, the decoration 14 may be applied after the deformation process.

According to a further preferred embodiment of the invention, the application of the decoration 14 is effected by screen printing after the deformation process. This is possible because smooth radii transitions are obtained by the deformation process according to the invention, so that the doctor blade can be moved over the resulting deformations and yet the ink will be applied uniformly and in good quality.

According to a particularly preferred embodiment of the invention, deformations that define a depression, or elevations having a height of not more than 0.5 mm are coated following the deformation process, and coating is accomplished by screen printing.

However, it is also possible to choose other printing methods to be able to coat elevations having a greater height.

Furthermore, according to yet another embodiment of the invention it is also possible to apply the printing ink already prior to the deformation process. This is possible due to the small lateral extension of the heat affected zone, i.e. of portion 3 of the sheet-like starting glass, achieved according to the invention. Here, the heat affected zone is defined as the area where the surface temperature of the substrate to be deformed exceeds the maximum allowable temperature of the applied ink. The maximum allowable temperature is defined as the temperature at which the properties of the ink change irreversibly, for example due to a color change of pigments, decomposition of an organic binder, or the like. This heat affected zone has to be spared by the decoration 14 to avoid overheating thereof.

### LIST OF REFERENCE NUMERALS

1 Shaped green glass or glass ceramic article
2 Region having a viscosity from 10¹³ to 10⁷ dPa·s during shaping
3 Region having a viscosity from 10⁹ to 10⁴ dPa·s, preferably from 10⁸ to 10⁴ dPa·s during shaping
4 Deformation
5 Support
6 Bottom of deformation
7 Shoulder of deformation
8 Edge of deformation
9 Wall of deformation
10 Circumferential indentation
11 Non-deformed region
12 Lower surface of sheet-like glass
13 Dimpled texture
14 Decoration
R1 Deformation radius 1
R2 Deformation radius 2
R3 Deformation radius 3
R4 Deformation radius 4

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

1. A shaped green glass or glass ceramic article obtained from a sheet-like starting glass, comprising:
at least one deformation of depth T, with:
T>(AdρBg)/(γI),
wherein
A=area to be lowered of the starting glass, in m²,
ρ=glass density, in kg/m³,
g=acceleration due to gravity, in m/s²,
γ=surface tension of the starting glass in the molten state, in N/m,
d=thickness of the starting glass, in m,
B=width of the deformation, in m,
I=circumference of the deformation, in m;
wherein after having been deformed, the surface of the shaped glass article has no defects greater than 1 μm.

2. The shaped green glass or glass ceramic article of claim 1, wherein the green glass or ceramic article further comprises at least one decoration on the surface.

3. The shaped green glass or glass ceramic article of claim 2, wherein the at least one decoration consists of a printing ink selected from the group consisting of a ceramic ink, an organic ink, a semi-organic ink, and a sol-gel ink.

4. The shaped green glass or glass ceramic article of claim 2, wherein the decoration is applied in the region of at least one deformation.

5. The shaped green glass or glass ceramic article of claim 4, wherein the deformation is formed as a depression or as an elevation, wherein the elevation has a maximum height of 0.5 mm, and wherein the decoration is applied by screen printing.

6. The shaped green glass or glass ceramic article of claim 1, wherein after having been deformed, the surface of the shaped glass article has no defects greater than 0.1 μm.

7. A shaped green glass or glass ceramic article obtained from a sheet-like starting glass, comprising:
at least one deformation of a depth between 0.1 and 2.5 mm, wherein said deformation has rounded deformation edges and defines shoulders, walls, edges, and a bottom,
wherein the shoulder is a region of the shaped green glass or glass ceramic article where a higher region transitions into the wall of the deformation, and
wherein the edge is a region of the shaped green glass or glass ceramic article in which the wall of the deformation transitions into the lower region, and
wherein the bottom is a region of the shaped green glass or glass ceramic article which is located between and limited by the walls of the deformation, and
wherein the bottom has a concavely or convexly curved shape.

8. The shaped green glass or glass ceramic article of claim 7, further comprising a surface profile of the deformation formed so that the radii of the edges are smaller than the deformation radii of the shoulders.

9. The shaped green glass or glass ceramic article of claim 8, wherein the deformation radii of the shoulders are in a range from 1 to 8 mm, and wherein the deformation radii of the edges are in a range from 0.4 to 3 mm.

10. The shaped green glass or glass ceramic article of claim 9, wherein a ratio V_{S/R} of the shoulder radii to the edge radii is in a range from 2 to 4.

11. The shaped green glass or glass ceramic article of claim 8, wherein the deformation radii of the shoulders are in a range from 2 to 6.5 mm, and wherein the deformation radii of the edges are in a range from 0.5 to 2.5 mm.

12. The shaped green glass or glass ceramic article of claim 11, wherein a ratio V_{S/R} of the shoulder radii to the edge radii is in a range from 2 to 4.

13. The shaped green glass or glass ceramic article of claim 6, wherein the green glass or ceramic article further comprises at least one decoration on the surface, and wherein the at least one decoration consists of a printing ink selected from the group consisting of a ceramic ink, an organic ink, a semi-organic ink, and a sol-gel ink.

14. A method for producing, without a mold, a shaped green glass or glass ceramic article having a predefined geometry, wherein the green glass or ceramic article has at least one decoration made of a printing ink, and wherein the method comprises at least the steps of:
providing a sheet-like starting glass;
supporting the starting glass;
heating a portion of the starting glass so that in said portion a viscosity of the starting glass is obtained from 10⁹ to 10⁴ dPa·s, and so that at the points where the starting glass is supported a viscosity of the starting glass does not fall below 10¹² dPa·s, wherein the heating is accomplished using at least one laser beam along a closed line and in such a manner that the temperature range relevant for nucleation and distinguished by a strong formation of crystallization nuclei is traversed in not more than 50 seconds;
deforming the heated starting glass by action of an external force until the predefined geometry of the glass article is obtained;
applying at least one printing ink to a predetermined region of the starting glass;
optionally converting the green glass into a glass ceramic by subsequent ceramization.

15. The method of claim 14, wherein the applying of the at least one printing ink is effected by a printing process.

16. The method of claim 14, wherein the applying of the at least one printing ink comprises applying the ink in the region of the deformation, inter alia.

17. The method of claim 16, wherein the deformation is formed as a depression or as an elevation, wherein the elevation has a maximum height of 0.5 mm, and wherein further the applying of the printing ink is accomplished by screen printing.

19. The method of claim 14, wherein the printing ink is selected from the group consisting of a ceramic ink, an organic ink, a semi-organic ink, and a sol-gel ink.

20. The method of claim 14, wherein said heating step comprises heating said portion of the starting glass so that in said portion a viscosity of the starting glass is from 10⁸ to 10⁴ dPa·s, and so that at the points where the starting glass is supported a viscosity of the starting glass does not fall below 10¹³ dPa·s.

21. The method of claim 10, wherein said printing process is selected from the group consisting of screen printing, pad printing, jet printing, and inkjet printing.
